(19) United States
(12) Patent Application Publication
(10) Pub. No.: US 2021/0107822 A1
(43) Pub. Date: Apr. 15, 2021

(54) METHOD FOR LASER CUTTING BENT GLASS FOR SHAPE AND OPTICS MATCH

(71) Applicant: CORNING INCORPORATED, CORNING, NY (US)

(72) Inventors: Timothy Joseph Bourque, Garden City, MI (US); Thomas Michael Cleary, Elmira, NY (US); John Frederic MacQuarrie, Davidson, NC (US)

(21) Appl. No.: 16/956,051

(22) PCT Filed: Dec. 15, 2018
(86) PCT No.: PCT/US2018/065879

§ 371 Date: Jun. 19, 2020

Related U.S. Application Data
(60) Provisional application No. 62/608,906, filed on Dec. 21, 2017.

(51) Int. Cl. C03B 23/025; B23K 26/402; C03B 33/04; C03B 33/02; B32B 17/10

(52) U.S. Cl. CPC C03B 23/0252; B23K 26/402; C03B 33/04; B23K 2103/54; B32B 17/10036; B32B 17/10137; C03B 33/0222

(57) ABSTRACT

Embodiments of the disclosure relate to a method of preparing a multi-piece laminated article. In the method a first glass ply and a second glass ply are co-sagged. The first glass ply is laser cut to form a first primary piece and a first secondary piece, and the second glass ply is laser cut to form a second primary piece and a second secondary piece. The first primary piece and the second primary piece each define a hole into which the first secondary piece and the second secondary piece, respectively, fit. The first primary piece and the second primary piece are laminated to each other to form a first laminated piece, and the first secondary piece and the second secondary piece are laminated to each other to form a second laminated piece. The method can be used to prepare, for example, automotive glazing.

### CROSS-REFERENCE TO RELATED APPLICATIONS

This application claims the benefit of priority under 35 U.S.C. § 119 of U.S. Provisional Application Ser. No. 62/608,906 filed on Dec. 21, 2017, the content of which is relied upon and incorporated herein by reference in its entirety.

### BACKGROUND

The disclosure relates generally to a multi-part laminate article usable, e.g., as a vehicle glazing. Curved glass laminates find use in many applications, particularly for vehicle or automotive glazing, including windows, roofs, and other vehicle panels. Typically, curved glass sheets for such applications have been formed from relatively thick sheets of glass material. To improve shape consistency between individual glass layers of the laminate article, the glass materials may be shaped to the desired shape/curvature via a co-forming process, such as a co-sagging process. In certain applications, a multi-part laminate article may be desired. Generally, such multi-part laminate articles are formed by shaping a first piece, removing a portion of the first piece, shaping a second piece, and then mounting the two pieces together. However, this process is known to result in poor reflected optics and discontinuous curvatures between the two pieces.

### SUMMARY

In one aspect, embodiments of a method of preparing a multi-piece laminated article are provided. In the method, a first glass ply and a second glass ply are co-sagged. The first glass ply is laser cut to form a first primary piece and a first secondary piece, and the second glass ply is laser cut to form a second primary piece and a second secondary piece. The first primary piece and the second primary piece each define a hole into which the first secondary piece and the second secondary piece, respectively, fit. The first primary piece and the second primary piece are laminated to each other to form a first laminated piece, and the first secondary piece and the second secondary piece are laminated to each other to form a second laminated piece.

In another aspect, embodiments of a multi-piece curved glass laminate article are provided. The multi-piece glass laminate article includes a primary piece and a secondary piece. The primary piece has a hole formed therethrough, and the secondary piece has a size and a shape configured to fit into the hole of the primary piece. The primary piece and the secondary piece each include a first glass ply laminated to a second glass ply. In particular, the first glass ply of the secondary piece is cut from the first glass ply of the primary piece, and the second glass ply of the secondary piece is cut from the second glass ply of the primary piece.

In still another aspect, embodiments of an automotive glazing are provided. The automotive glazing includes a window, an insert, and a track system. The window has a first exterior surface and a first interior surface in which the first exterior surface and the first interior surface define a thickness of the window and in which a hole is formed through the thickness of the window. The insert has a second exterior surface and a second interior surface, and the insert has a size and a shape configured to fit into the hole of the window. The track system is located on the first interior surface of the window and is configured to allow the insert to move from a first position in which the insert obstructs a first area of the aperture to a second position in which the insert obstructs a second area of the aperture with the second area being smaller than the first area. Further, the window and the insert are laminated articles cut from the same two co-sagged glass plies.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 is a flow diagram for preparing a multi-part laminated article, according to an exemplary embodiment.

FIG. 2 is a schematic view of a window shape being cut from the stacked glass sheets after co-sagging, according to an exemplary embodiment.

FIG. 3 is a schematic, cross-sectional, exploded view showing stacking of glass sheets for co-sagging, according to an exemplary embodiment.

FIG. 4 is a schematic, cross-sectional view showing stacked glass sheets supported on a bending ring, according to an exemplary embodiment.

FIG. 5 is a cross-sectional view showing the stacked glass sheets of FIG. 4 supported by a bending ring within a heating station, according to an exemplary embodiment.

FIG. 6 is a detailed view of the stacked glass sheets of FIG. 4, according to an exemplary embodiment.

FIG. 7 is an exploded view of the primary piece and the secondary piece of the multi-piece laminate article, according to an exemplary embodiment.

FIG. 8 is a schematic view of a primary window piece with a secondary insert piece, according to an exemplary embodiment.

FIG. 9 depicts a rear view of a primary window piece with a secondary insert piece along with a track system for moving the secondary insert piece, according to an exemplary embodiment.

FIG. 10 depicts a roof panel of a vehicle having a primary window piece and a secondary insert piece, according to an exemplary embodiment.

FIG. 11 depicts regions of glazing on a vehicle suitable for placement of a primary window piece and a secondary insert piece, according to exemplary embodiments.

### DETAILED DESCRIPTION

Embodiments of the present disclosure relate to multi-piece glass laminate articles, in particular to glazing for automobiles, and to a method of making same. In embodiments, the multi-piece glass laminate articles are referred to as “hole-in-glass” designs. According to embodiments disclosed herein, the hole-in-glass design involves cutting a “slug” from a primary glass laminate piece. The slug acts as a movable insert for the primary glass laminate piece such that in a closed configuration the insert blocks the hole of the primary glass laminate piece and in an open configuration the insert is clear of at least a portion of the hole in the primary glass laminate piece, and may be substantially clear of the entire hole in the primary glass laminate piece. Advantageously, the present disclosure provides a method whereby the primary glass laminate piece and movable insert are formed from the same plies of co-sagged glass. In this way, the shape mismatch and optical distortion are avoided because the primary glass laminate piece and the movable insert have a continuous curvature and matching optical characteristics.

Previously, hole-in-glass designs were prepared by cutting a hole in the primary piece, typically through waterjet cutting, and then discarding the slug (i.e., the portion removed to make the hole in the primary piece). The primary piece was then sagged to the desired curvature and thermally tempered to enhance the strength. A second piece, corresponding in size to the hole of the primary piece was cut from a separate glass ply, and this second piece was sagged and tempered. In certain circumstances, this process resulted in a primary piece and a secondary piece having shape discontinuities between the hole and the secondary piece and between the curvature of the secondary piece and of the primary piece. Further, thermal processing, including tempering and quenching, resulted in optical distortions (e.g., poor reflected optics), especially around the hole in the primary piece. Moreover, the slug cut from the primary piece was simply discarded, making the process somewhat wasteful.

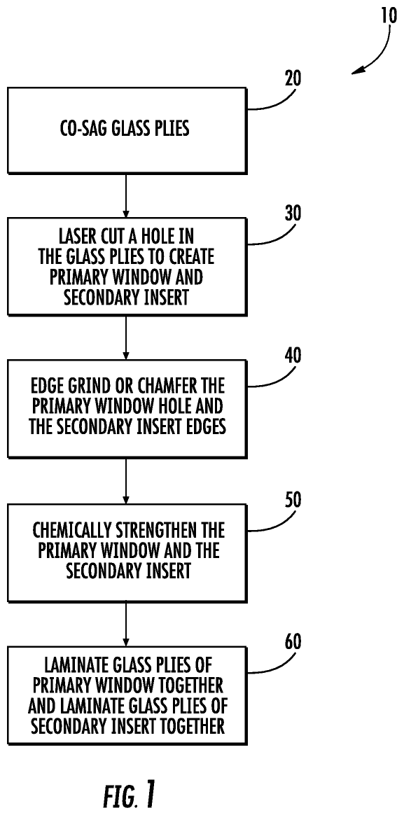

According to the presently disclosed method, these disadvantages are overcome. In the presently disclosed method, summarized in the flow diagram of FIG. 1, the slug cut from the primary piece is not discarded but instead is used as the secondary piece, thereby reducing waste, enhancing optical matching between the pieces, and providing continuous curves across the multi-piece laminate article. Further, no thermal tempering is performed on the primary piece or secondary piece of the multi-piece glass laminate article, which avoids optical distortions and quench marks. A brief summary of the steps of the method 10 is now provided. In a first step 20, two glass plies are co-sagged to produce a desired curvature. In a second step 30, the glass plies are laser cut to create the primary piece (e.g., window) and the secondary piece (e.g., insert). Next, in step 40, the hole in the primary piece and/or the peripheral edges of the secondary piece are optionally ground or chamfered to a desired finish. Thereafter, in step 50, one or both plies of the first and/or secondary pieces are chemically strengthened. Finally, in step 60, the plies of the primary piece are laminated together, and the plies of the secondary piece are laminated together. Each of these steps of the method 10 are described in greater detail below.

Referring to FIG. 2, by way of example, glass plies 112 or 114 (also referred to as a preform) are cut from their individual stock glass sheets 100. The shape of the perimeter 102 is defined by a flat pattern as needed to produce the desired shape following the co-sagging process as described in greater detail below. After glass sheets 112 and 114 are cut from the stock glass sheet, the edges may be ground to break the sharp corners. In embodiments, the corners have radii of curvature of from 20 mm to 80 mm to minimize local stresses at the corners.

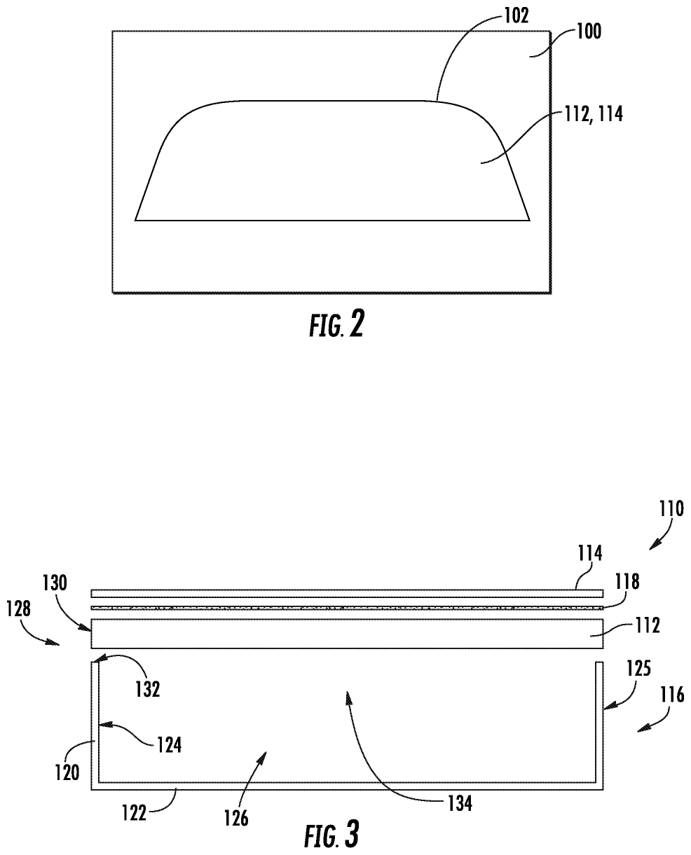

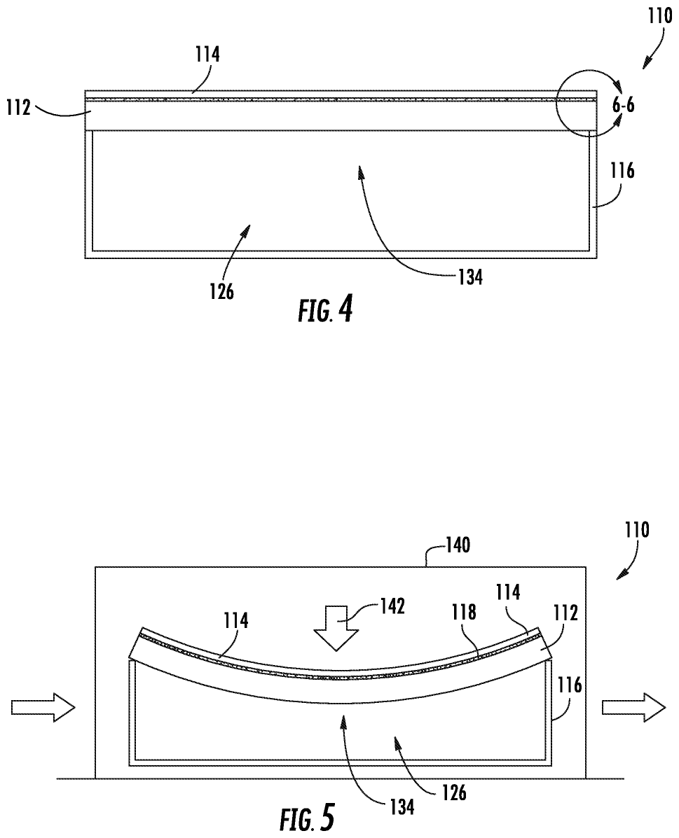

Referring to FIG. 3 and FIG. 4 regarding the co-sagging step 20, a system and process for forming a curved glass article is shown according to an exemplary embodiment. In general, system 110 includes one or more sheets of glass material, shown as a pair of glass plies 112 and 114, supported by a shaping frame, shown as bending ring 116. It should be understood that bending ring 116 may have a wide variety of shapes selected based on the shape of the glass plies to be supported, and use of the term ring does not necessarily denote a circular shape.

As shown in FIG. 3, bending ring 116 includes a support wall, shown as sidewall 120, and a bottom wall 122. Sidewall 120 extends upward and away from bottom wall 122. The radially inward facing surface 124 of sidewall 120 defines an open central region or cavity 126, and an upward facing surface of bottom wall 122 defines the lower end of cavity 126. A radially outward facing surface 125 is opposite of inward facing surface 124. The system 110 of FIG. 3 is one example of a system and process that can be used for the co-sagging step 20, but embodiments of this disclosure are not limited to a specific system or method of co-sagging or shaping glass plies.

As shown in FIG. 3 and FIG. 4, a separation material 118 is optionally deposited between the lower glass ply 112 and the upper glass ply 114. In general, separation material 118 is a material, such as hexagonal boron nitride, graphite, molybdenum disulfide, polytetrafluoroethylene, talc, calcium fluoride, cesium fluoride, tungsten disulfide, etc., that helps prevent plies 112 and 114 from bonding together during the heating stages of the curve formation. While the separation material 118 is depicted in FIG. 3 and FIG. 4 as a coherent layer, the separation material 118 can be, e.g., a powdered ceramic layer, a slurry layer, a foam layer, etc. Further, the separation material 118 can be sprayed, applied, or otherwise deposited onto either a lower surface of the upper glass ply 114 or an upper surface of the lower glass ply 112. Thus, when the upper glass ply 114 is stacked over the lower glass ply 112, the lower surface of upper glass ply 114 is in contact with separation material 118, and the upper surface of the lower glass ply 112 is in contact with the separation material 118. As can be seen in FIG. 3 and FIG. 4, in this arrangement, separation material 118 acts as a barrier between glass plies 112 and 114 during the co-sagging process.

To begin the co-sagging process, an outer region 128 of glass ply 112 adjacent the outer perimeter edge 130 of the glass ply is placed into contact with a support surface, shown as upward facing surface 132, of bending ring 116. In this arrangement, glass plies 112 and 114 are both supported by the contact between upward facing surface 132 with glass sheet 112 such that central regions 134 of glass plies 112 and 114 are supported over central cavity 126.

Next, referring to FIG. 5, bending ring 116, supported glass plies 112 and 114 and separation material 118 are moved into a heating station 140, such as an oven or serial indexing lehr. Within heating station 140, glass plies 112 and 114, separation material 118 and bending ring 116 are heated (e.g., to near or at the softening temperature of the glass material of glass plies 112 and 114) while glass plies 112 and 114 are supported on bending ring 116. As glass plies 112 and 114 are heated, a shaping force, such as the downward force 142, causes central region 134 of glass plies 112 and 114 to deform or sag downward into central cavity 126 of bending ring 116.

In specific embodiments, the downward force 142 is provided by gravity. In some embodiments, the downward force 142 may be provided via air pressure (e.g., creating a vacuum on the convex side of glass plies 112 and 114, blowing air on the concave side of glass ply 114, via press, etc.) or through a contact-based molding machine. Regardless of the source of the deforming force 142, this procedure results in glass plies 112 and 114 having a curved shape as shown in FIG. 5.

After a period of time determined to allow glass plies 112 and 114 to develop the desired curved shape, bending ring 116 along with the supported glass plies 112 and/or 114 are then cooled to room temperature. Thus, the shaped, deformed, or curved glass plies 112 and 114 are allowed to cool, fixing glass plies 112 and 114 into the curved shape created within heating station 140. Once cooled, curved glass plies 112 and 114 are removed from bending ring 116 and another set of flat glass sheets are placed onto bending ring 116, and the shaping process is repeated.

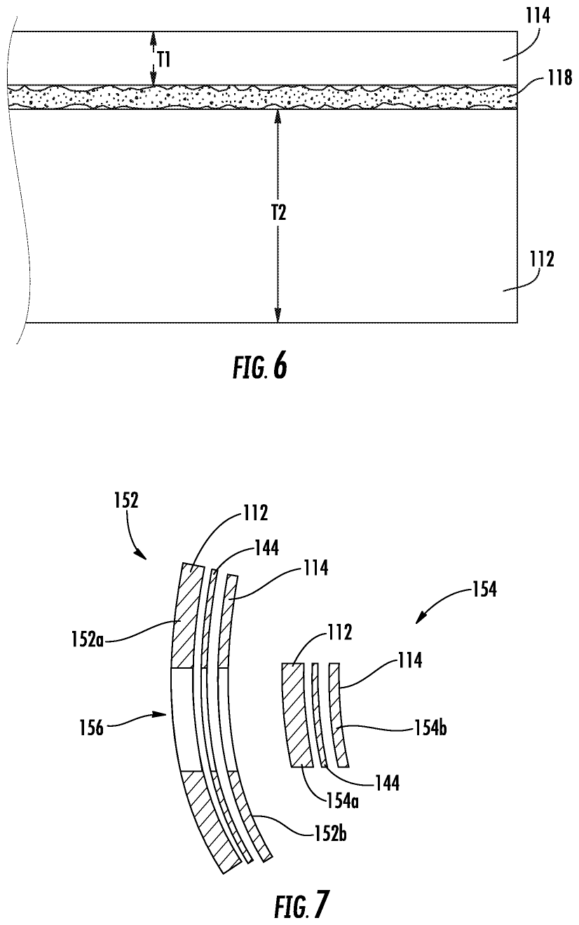

As shown in FIG. 6, glass ply 114 has a thickness, shown as T1, and glass ply 112 has a thickness, shown as T2. In general, T1 is different from T2, and specifically T2 is greater than T1. In various embodiments, T2 is at least 2.5 times greater than T1, and in other embodiments, Ti is at least 2.5 times greater than T2. In specific embodiments, T2 is between 1.5 mm and 4 mm, and T1 is between 0.3 mm and 1 mm, and in even more specific embodiments, T1 is less than 0.6 mm. In specific embodiments: T2 is 1.6 mm and T1 is 0.55 mm; T2 is 2.1 mm and T1 is 0.55 mm; T2 is 2.1 mm and T1 is 0.7 mm; T2 is 2.1 mm and T1 is 0.5 mm; T2 is 2.5 mm and T1 is 0.7 mm. In the embodiment shown in FIG. 4, the thicker glass ply 112 is located below the thinner glass ply 114 when stacked on bending ring 116. However, it should be understood that in other embodiments, the thinner glass ply 114 could instead be located below thicker glass ply 112 in the stack supported by bending ring 116.

In various embodiments, glass ply 112 is formed from a first glass material/composition, and glass ply 114 is formed from a second glass material/composition different from the first material. In some such embodiments, the first glass material has a viscosity that is different from the viscosity of the second glass material during heating within heating station 140. While a wide variety of glass materials may be used to form glass plies 112 and/or 114, in specific embodiments, the first glass material of ply 112 is a soda lime glass, and the second glass material of ply 114 is an alkali aluminosilicate glass composition or an alkali aluminoborosilicate glass composition. Additional exemplary materials for glass plies 112 and 114 are identified in detail further below.

After co-sagging the glass plies 112 and 114 in step 20, the glass plies 112 and 114 are each laser cut in step 30. As shown in FIG. 7, the laser-cut glass plies 112 and 114 are used to form a primary laminate piece 152 and a secondary laminate piece 154. In particular, primary piece 152 includes a first primary piece 152a from the glass ply 112 and a second primary piece 152b from the glass ply 114. Similarly, the secondary piece 154 includes a first secondary piece 154a from the glass ply 112 and a second secondary piece 154b from the glass ply 114. The first and second secondary pieces 154a and 154b are created by cutting a hole 156 into the first and second primary pieces 152a and 152b. As mentioned above, this is referred to as a “hole-in-glass” design. In embodiments, the glass plies 112 and 114 are cut at the same time, i.e., the laser simultaneously cuts through the stacked plies 112 and 114. Because the primary piece 152 and the secondary piece 154 are cut from the same co-sagged glass plies, the optical characteristics of the primary piece 152 and of the secondary piece 154 are identical, reducing the potential for optical distortions, and the primary piece 152 and the secondary piece 154 will have a continuous curvature.

In embodiments, the laser used for laser cutting the glass plies 112 and 114 is operable to emit a laser beam having a wavelength suitable for imparting thermal energy to a surface of the glass article. Suitable laser sources include a diode-pumped q-switched solid-state Nd:YAG laser or Nd:YVO4 laser with an average power from about 6 Watts to about 35 Watts and pulse peak power of at least 2 kilowatts. The pulse duration of the laser may be in the range from about 1 nanosecond to about 50 nanoseconds, for example, from about 15 nanoseconds to about 22 nanoseconds. The pulse repetition rate may be in the range from about 10 kilohertz to about 200 kilohertz, for example from about 40 kilohertz to about 100 kilohertz. As discussed hereinabove, suitable lasers for using the separation method discussed herein may produce a laser beam in the visible light range (i.e., from about 380 nanometers to about 619 nanometers (380 nanometers corresponds to photon energy of about 3.26 eV; 2.00 eV corresponds to the wavelength of about 619 nanometers)). Such a laser may produce a laser beam at a wavelength from about 380 to about 570 nanometers, for example at a wavelength of about 532 nanometers. Lasers producing beams at this wavelength have high efficiency of transferring energy to the glass plies. This may be attributed to combination of the interaction of the laser beam with the glass plies and the high photon energy carried by the laser beam having a 532 nanometer wavelength. Lasers used according to the disclosed method may have photon energy of at least 2 eV. It is noted that a wavelength of 532 nanometers, the photon energy is 2.32 eV; longer wavelength has lower photon energy, and shorter wavelength has higher photon energy.

Optionally, after the laser-cutting step 30, the edges of the hole 156 formed into the first and second primary pieces 152a and 152b are ground or chamfered to produce a desired finish in method step 40. That is, the sharp (e.g., 90°) edges can be ground to produce rounded or curved edges or chamfered to produce flat, angled edges. Similarly, the peripheral edges of the first and second secondary pieces 154a and 154b can also be ground or chamfered to produce a desired finish. Further, in an optional step 50, all or some of the first and second primary pieces 152a and 152b and of the first and secondary pieces 154a and 154b are chemically strengthened. Specific exemplary embodiments of chemical strengthening are provided in greater detail further below. However, if the first and second primary pieces 152a and 152b and/or the first and second secondary pieces 154a and 154b are produced from strengthened glass plies 112 and/or 114, then step 50 can be skipped. Further, depending on the particular application and on whether strengthening is needed, the method can exclude the step 50 of chemical strengthening and also exclude the use of chemically strengthened glass plies.

In step 60, the first and second primary pieces 152a and 152b are laminated together to form the primary laminate piece 152, and the first and second secondary pieces 154a and 154b are laminated together to form the secondary laminate piece 154. As can be seen in FIG. 7, a polymer interlayer 144 is provided between the first and second primary pieces 152a and 152b and between the first and second secondary pieces 154a and 154b. In an exemplary embodiment, the polymer interlayer is polyvinyl butyral. The laminating process involves assembling the first and second primary pieces 152a and 152b with a polymer interlayer 144 and the first and second secondary pieces 154a and 154b with a polymer interlayer 144 and baking the components at a temperature sufficient to cause the polymer interlayers 144 to soften or melt so as to bind the first and second primary pieces 152a and 152b together and bind the first and second secondary pieces 154a and 154b together. In embodiments, pressure is also applied to the pieces or a vacuum is created to enhance the bonding between the layers.

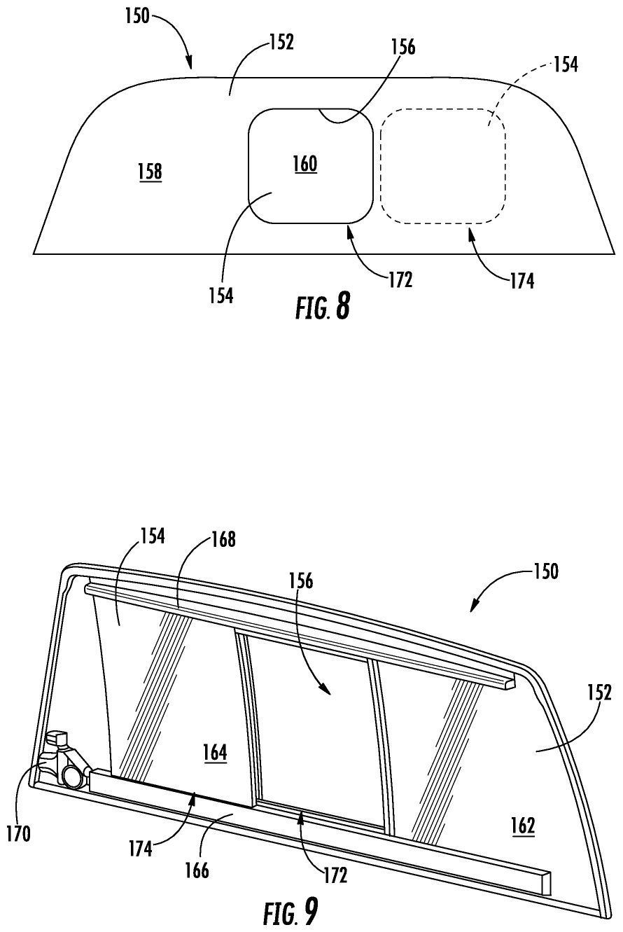

In one example, as can be seen in FIG. 8, the primary piece 152 and the secondary piece 154 can form a rear window 150, such as the rear window of a pickup truck. In this regard, the primary piece 152 is a window with a hole 156 for a vent to the outside, and the secondary piece 154 is an insert that plugs the hole 156. In this way, the secondary piece 154 is able to move from a first position 172 in which the secondary piece 154 obstructs the hole 156 to a second position 174 in which the secondary piece 154 does not obstruct the hole 156 or obstructs a lesser area of the hole 156 than is obstructed when the secondary piece 154 is in the first position 172. Further, because of the matching curvature between the primary piece 152 and the secondary piece 154, in embodiments, the secondary piece 156 is able to inserted into the hole 156 in such a way that an exterior surface 158 of the primary piece 152 is flush with an exterior surface 160 of the secondary piece 154 and/or the interior surface 162 (as shown in FIG. 9) of the primary piece 152 is flush with the interior surface 164 (as shown in FIG. 9) of the secondary piece 154. As used in this context, the “interior surface” refers to the surface of the primary piece 152 and/or secondary piece 154 that faces the interior of the vehicle, whereas the “exterior surface” refers to the surface of the primary piece 152 and/or secondary piece 154 that faces away from the interior of the vehicle (i.e., that is exposed to the external environment of the vehicle).

FIG. 9 provides a rear, perspective view of the window 150. As can be seen, in embodiments, a track system comprising a lower track 166 and an upper track 168 is mounted to the interior surface 162 of the primary piece 152. The secondary piece 156 slides within the tracks 166 and 168 between the first position in which the hole 156 is substantially covered and the second position in which the hole 156 is substantially uncovered. In embodiments, movement of the secondary piece within the tracks 166 and 168 is facilitated by a motor 170, which is preferably controlled via a switch, voice command, touch screen, etc. located near a driver or passenger of the vehicle. In this way, the driver of the vehicle can transition the secondary piece 156 from the first position to the second position, and vice versa, without the driver having to take his or her eyes from the road. The track system shown in FIG. 9 is one example for implementing embodiments of this disclosure, but other systems for moving the secondary piece 154 may be used in some embodiments.

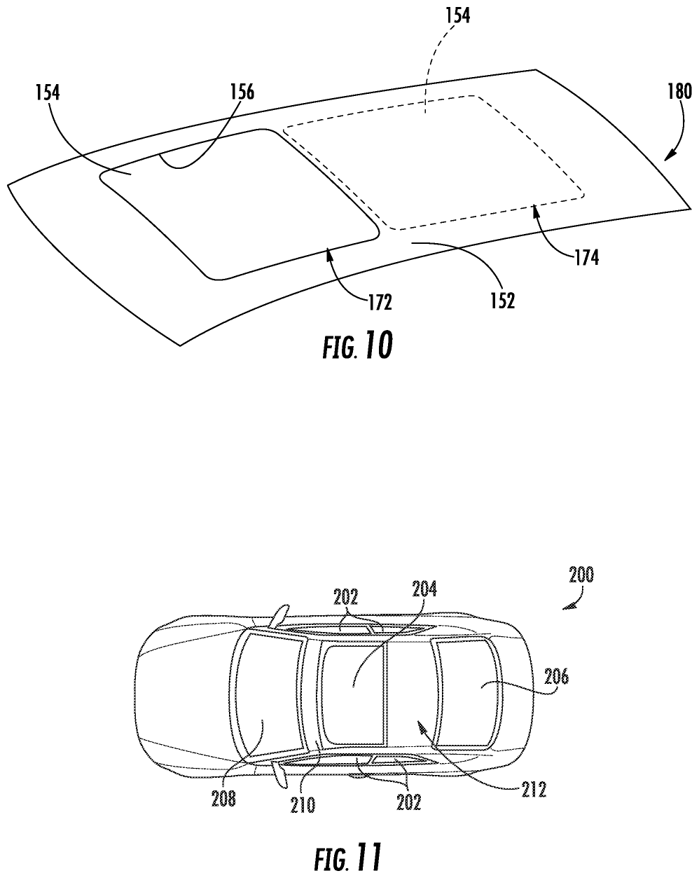

FIG. 10 provides another embodiment in which the primary piece 152 is a roof panel 180 of a vehicle. The secondary piece 154, like in the previous embodiment, moves from a first position 172 in which the secondary piece 154 obstructs the hole 156 to a second position 174 in which the secondary piece 154 does not obstruct the hole 156 or obstructs a lesser area of the hole 156 than is obstructed when the secondary piece 154 is in the first position 172. Also like the previous embodiment, such movement can be facilitated through the use of a track system.

Referring to FIG. 11, use of the multi-piece glass laminate article made from the primary piece 152 and the secondary piece 154 as part of a vehicle window, roof or side window, is shown. As shown, a vehicle 200 includes one or more side windows 202, a roof 204, a rear window 206 and/or a windshield 208. In general, any of the embodiments of glass laminate article discussed herein may be used for one or more side windows 202, a roof 204, a back window 206 and/or a windshield 208. In general, one or more side windows 202, a roof 204, a back window 206 and/or a windshield 208 are supported within an opening defined by vehicle frame or body 210 such that outer surface of glass ply 112 faces a vehicle interior 212. In this arrangement, outer surface of glass ply 114 faces toward the exterior of vehicle 200 and may define the outermost surface of vehicle 200 at the location of the glass article. As used herein, vehicle includes automobiles, rolling stock, locomotive, boats, ships, airplanes, helicopters, drones, space craft and the like. In other embodiments, glass laminate article may be used in a variety of other applications where thin, curved glass laminate articles may be advantageous, such as for architectural glass, building glass, etc.

Glass plies 112 and/or 114 suitable for use in the primary piece 152 and the secondary piece 154 can be formed from a variety of materials. In specific embodiments, glass ply 114 is formed from a chemically strengthened alkali aluminosilicate glass composition or an alkali aluminoborosilicate glass composition, and glass ply 112 is formed from a soda lime glass (SLG) composition. In specific embodiments, glass plies 112 and/or 114 are formed from a chemically strengthened material, such as an alkali aluminosilicate glass material or an alkali aluminoborosilicate glass composition, having a chemically strengthened compression layer having a depth of compression (DOC) in a range from about 30μm to about 90μm, and a compressive stress on at least one of the sheet's major surfaces of between 300 MPa to 1000 MPa. In some embodiments, the chemically strengthened glass is strengthened through ion exchange.

### Examples of Glass Materials and Properties

In various embodiments, glass plies 112 and/or 114 may be formed from any of a variety of strengthened glass compositions. Examples of glasses that may be used for glass plies 112 and/or 114 described herein may include alkali aluminosilicate glass compositions or alkali aluminoborosilicate glass compositions, though other glass compositions are contemplated. Such glass compositions may be characterized as ion exchangeable. As used herein, “ion exchangeable” means that the layer comprising the composition is capable of exchanging cations located at or near the surface of the glass layer with cations of the same valence that are either larger or smaller in size. In one exemplary embodiment, the glass composition of glass plies 112 and/or 114 comprises SiO₂, B₂O₃ and Na₂O, where (SiO₂+B₂O₃)≥66 mol. %, and Na₂O≥9 mol. %. Suitable glass compositions for glass plies 112 and/or 114, in some embodiments, further comprise at least one of K₂O, MgO, and CaO. In a particular embodiment, the glass compositions used in glass sheets 12 and/or 14 can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example of glass composition suitable for glass plies 112 and/or 114 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

Even further, another example of glass composition suitable for glass plies 112 and/or 114 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO) ≤7 mol. %.

In a particular embodiment, an alkali aluminosilicate glass composition suitable for glass plies 112 and/or 114 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio ((Al₂O₃+B₂O₃)/Σ modifiers)>1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio((Al₂O₃+B₂O₃)/Σmodifiers)>1.

In still another embodiment, glass plies 112 and/or 114 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO ≤69 mol. %; Na₂O+K₂O+B₂O₃+MgO+CaO+SrO>10 mol. %; 5 mol. %≤MgO+CaO+SrO≤8 mol. %; (Na₂O+B₂O₃)−Al₂O₃≤2 mol. %; 2 mol. %≤Na₂O−Al₂O₃≤6 mol. %; and 4 mol. %≤(Na₂O+K₂O)−Al₂O₃≤10 mol. %.

In an alternative embodiment, glass plies 112 and/or 114 may comprise an alkali aluminosilicate glass composition comprising: 2 mol % or more of Al₂O₃ and/or ZrO₂, or 4 mol % or more of Al₂O₃ and/or ZrO₂. In one or more embodiments, glass plies 112 and/or 114 comprise a glass composition comprising SiO₂ in an amount in the range from about 67 mol % to about 80 mol %, Al₂O₃ in an amount in a range from about 5 mol % to about 11 mol %, an amount of alkali metal oxides (R₂O) in an amount greater than about 5 mol % (e.g., in a range from about 5 mol % to about 27 mol %). In one or more embodiments, the amount of R₂O comprises Li₂O in an amount in a range from about 0.25 mol % to about 4 mol %, and K₂O in an amount equal to or less than 3 mol %. In one or more embodiments, the glass composition includes a non-zero amount of MgO, and a non-zero amount of ZnO.

In other embodiments, glass plies 112 and/or 114 are formed from a composition that exhibits SiO₂ in an amount in the range from about 67 mol % to about 80 mol %, Al₂O₃ in an amount in the range from about 5 mol % to about 11 mol %, an amount of alkali metal oxides (R₂O) in an amount greater than about 5 mol % (e.g., in a range from about 5 mol % to about 27 mol %), wherein the glass composition is substantially free of Li₂O, and a non-zero amount of MgO; and a non-zero amount of ZnO.

In other embodiments, glass plies 112 and/or 114 are an aluminosilicate glass article comprising: a glass composition comprising SiO₂ in an amount of about 67 mol % or greater; and a sag temperature in a range from about 600° C. to about 710° C. In other embodiments, glass plies 112 and/or 114 are formed from an aluminosilicate glass article comprising: a glass composition comprising SiO₂ in an amount of about 68 mol % or greater; and a sag temperature in a range from about 600° C. to about 710° C. (as defined herein).

In some embodiments, glass plies 112 and/or 114 are formed from different glass materials from each other that differs in any one or more of composition, thickness, strengthening level, and forming method (e.g., float formed as opposed to fusion formed). In one or more embodiments, glass plies 112 and/or 114 described herein have a sag temperature of about 710° C., or less or about 700° C. or less. In one or more embodiments, one of the glass plies 112 and 114 is a soda lime glass sheet, and the other of the glass plies 112 and 114 is any one of the non-soda lime glass materials discussed herein. In one or more embodiments, glass plies 112 and/or 114 comprises a glass composition comprising SiO₂ in an amount in the range from about 68 mol % to about 80 mol %, Al₂O₃ in an amount in a range from about 7 mol % to about 15 mol %, B₂O₃ in an amount in a range from about 0.9 mol % to about 15 mol %; a non-zero amount of P₂O₅ up to and including about 7.5 mol %, Li₂O in an amount in a range from about 0.5 mol % to about 12 mol %, and Na₂O in an amount in a range from about 6 mol % to about 15 mol %.

In some embodiments, the glass composition of glass plies 112 and/or 114 may include an oxide that imparts a color or tint to the glass articles. In some embodiments, the glass composition of glass plies 112 and/or 114 includes an oxide that prevents discoloration of the glass article when the glass article is exposed to ultraviolet radiation. Examples of such oxides include, without limitation, oxides of: Ti, V, Cr, Mn, Fe, Co, Ni, Cu, Ce, W, and Mo.

Glass plies 112 and/or 114 may have a refractive index in the range from about 1.45 to about 1.55. As used herein, the refractive index values are with respect to a wavelength of 550 nm. Glass plies 112 and/or 114 may be characterized by the manner in which it is formed. For instance, glass plies 112 and/or 114 may be characterized as float-formable (i.e., formed by a float process), down-drawable and, in particular, fusion-formable or slot-drawable (i.e., formed by a down draw process such as a fusion draw process or a slot draw process). In one or more embodiments, glass plies 112 and/or 114 described herein may exhibit an amorphous microstructure and may be substantially free of crystals or crystallites. In other words, in such embodiments, the glass articles exclude glass-ceramic materials.

In one or more embodiments, glass plies 112 and/or 114 exhibits an average total solar transmittance of about 88% or less, over a wavelength range from about 300 nm to about 2500 nm, when glass plies 112 and/or 114 has a thickness of 0.7 mm. For example, glass plies 112 and/or 114 exhibits an average total solar transmittance in a range from about 60% to about 88%, from about 62% to about 88%, from about 64% to about 88%, from about 65% to about 88%, from about 66% to about 88%, from about 68% to about 88%, from about 70% to about 88%, from about 72% to about 88%, from about 60% to about 86%, from about 60% to about 85%, from about 60% to about 84%, from about 60% to about 82%, from about 60% to about 80%, from about 60% to about 78%, from about 60% to about 76%, from about 60% to about 75%, from about 60% to about 74%, or from about 60% to about 72%.

In one or more embodiments, glass plies 112 and/or 114 exhibit an average transmittance in the range from about 75% to about 85%, at a thickness of 0.7 mm or 1 mm, over a wavelength range from about 380 nm to about 780 nm. In some embodiments, the average transmittance at this thickness and over this wavelength range may be in a range from about 75% to about 84%, from about 75% to about 83%, from about 75% to about 82%, from about 75% to about 81%, from about 75% to about 80%, from about 76% to about 85%, from about 77% to about 85%, from about 78% to about 85%, from about 79% to about 85%, or from about 80% to about 85%. In one or more embodiments, glass sheets 12 and/or 14 exhibits Tᵤᵥ₋₃₈₀ or Tᵤᵥ₋₄₀₀ of 50% or less (e.g., 49% or less, 48% or less, 45% or less, 40% or less, 30% or less, 25% or less, 23% or less, 20% or less, or 15% or less), at a thickness of 0.7 mm or 1 mm, over a wavelength range from about 300 nm to about 400 nm.

In one or more embodiments, glass plies 112 and/or 114 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In one or more embodiments, glass plies 112 and/or 114 may be strengthened mechanically by utilizing a mismatch of the coefficient of thermal expansion between portions of the article to create a compressive stress region and a central region exhibiting a tensile stress. In some embodiments, the glass article may be strengthened thermally by heating the glass to a temperature below the glass transition point and then rapidly quenching.

In one or more embodiments, glass plies 112 and/or 114 may be chemically strengthening by ion exchange. In the ion exchange process, ions at or near the surface of glass plies 112 and/or 114 are replaced by—or exchanged with—larger ions having the same valence or oxidation state. In those embodiments in which glass plies 112 and/or 114 comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into glass plies 112 and/or 114 generate a stress.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

Aspect 1 of this disclosure pertains to a method of preparing a multi-piece laminated article, comprising the steps of: co-sagging a first glass ply and a second glass ply; laser cutting the first glass ply to form a first primary piece and a first secondary piece and the second glass ply to form a second primary piece and a second secondary piece, the first primary piece and the second primary piece each defining a hole into which the first secondary piece and the second secondary piece, respectively, fit; and laminating the first primary piece and the second primary piece to each other to form a first laminated piece, and laminating the first secondary piece and the second secondary piece to each other to form a second laminated piece.

Aspect 2 of this disclosure pertains to the method of Aspects 1, further comprising the step of chemically strengthening the first primary piece and the first secondary piece after the step of laser cutting.

Aspect 3 of this disclosure pertains to the method of Aspect 1 or 2, further comprising the step of chemically strengthening the second primary piece and the second secondary piece after the step of laser cutting.

Aspect 4 of this disclosure pertains to the method of any one of the preceding Aspects 1 to 3, wherein the first glass ply is an alkali aluminosilicate glass composition or an alkali aluminoborosilicate glass composition.

Aspect 5 of this disclosure pertains to the method of any of the preceding Aspects 1 to 4, wherein the second glass ply is a soda lime glass composition.

Aspect 6 of this disclosure pertains to the method of any one of the preceding Aspects 1 to 5, wherein the first glass ply has an average thickness, T1, and the second glass ply has an average thickness, T2, wherein T1 is at least 2.5 times greater than T2 or T2 is at least 2.5 times greater than T1.

Aspect 7 of this disclosure pertains to the method of any one of the preceding Aspects 1 to 6, wherein the first glass ply has a thickness of from 0.3 mm to 1 mm.

Aspect 8 of this disclosure pertains to the method of any one of the preceding Aspects 1 to 7, wherein the second glass ply has a thickness of from 1.5 mm to 4 mm.

Aspect 9 of this disclosure pertains to the method of any one of the preceding Aspects 1 to 8, and wherein the method further comprises the step of grinding or chamfering edges of the hole of the least one of the first primary piece and the second primary piece and peripheral edges of at least one of the first secondary piece and the second secondary piece.

Aspect 10 of this disclosure pertains to the method of any one of the preceding Aspects 1 to 9, wherein the method comprises no step of thermally tempering any of the first primary piece, the second primary piece, the first secondary piece, and the second secondary piece.

Aspect 11 of this disclosure pertains to the method of any one of the preceding Aspects 1 to 10, further comprising the steps of mounting the second laminated piece to the first laminated piece with a track system configured to allow the second laminated piece to move from a first position in which the second laminated piece obstructs a first area of the hole to a second position in which the second laminated piece obstructs a second area of the hole, the second area being smaller than the first area.

Aspect 12 of this disclosure pertains to the method of any one of the preceding Aspects 1 to 11, wherein the first laminated piece comprises an outer surface of the first primary piece facing an inner surface of the second primary piece, and the second laminated piece comprises an outer surface of the first secondary piece facing an inner surface of the second secondary piece.

Aspect 13 of this disclosure pertains to the method of Aspect 12, wherein the outer surfaces of the first and second primary pieces are convex and the inner surfaces of the first and second secondary pieces are concave.

Aspect 14 of this disclosure pertains to a multi-piece curved glass laminate article, comprising: a primary piece having a hole formed therethrough, the primary piece comprising a first glass ply laminated to a second glass ply; a secondary piece, wherein the secondary piece has a size and a shape configured to fit into the hole of the primary piece and wherein the secondary piece comprises a first glass ply laminated to a second glass ply; wherein the first glass ply of the secondary piece is cut from the first glass ply of the primary piece; and wherein the second glass ply of the secondary piece is cut from the second glass ply of the primary piece.

Aspect 15 of this disclosure pertains to the multi-piece curved glass laminate article of Aspect 14, wherein the first glass plies are an alkali aluminosilicate glass or an alkali aluminoborosilicate glass.

Aspect 16 of this disclosure pertains to the multi-piece curved glass laminate article of Aspect 14 or 15, wherein the second glass plies are a soda lime glass.

Aspect 17 of this disclosure pertains to the multi-piece curved glass laminate article of one of Aspects 14 to 16, wherein the first glass plies have an average thickness, T1, and the second glass plies have an average thickness, T2, wherein T1 is at least 2.5 times greater than T2 or T2 is at least 2.5 times greater than T1.

Aspect 18 of this disclosure pertains to the multi-piece curved glass laminate article of any one of Aspects 14 to 17, wherein the first glass plies have an average thickness of from 0.3 mm to 1 mm.

Aspect 19 of this disclosure pertains to the multi-piece curved glass laminate article of any one of Aspects 14 to 18, wherein the second glass plies have an average thickness of from 1.5 mm to 4 mm.

Aspect 20 of this disclosure pertains to the multi-piece curved glass laminate article of any one of Aspects 14 to 19, further comprising a track system configured to allow the secondary piece to move from a first position in which the secondary piece obstructs a first area of the hole to a second position in which the secondary piece obstructs a second area of the hole, the second area being smaller than the first area.

Aspect 21 of this disclosure pertains to the multi-piece curved glass laminate article of Aspect 20, wherein, in the first position, an outer surface of the first ply of the secondary piece is flush with an outer surface of the first ply of the primary piece.

Aspect 22 of this disclosure pertains to the multi-piece curved glass laminate article of any one of Aspects 14 to 21, wherein the first glass plies are chemically strengthened glass plies.

Aspect 23 of this disclosure pertains to the multi-piece curved glass laminate article of any one of Aspects 14 to 22, wherein the first glass ply is curved, and the second glass ply is curved.

Aspect 24 of this disclosure pertains to the multi-piece curved glass laminate article of any one of Aspects 14 to 23, wherein the primary piece comprises a primary inner surface and the secondary piece comprises a secondary inner surface; wherein, when the secondary piece is disposed in the hole of the primary piece, the primary and secondary inner surfaces compose a composite inner surface comprising a continuous curvature across the primary and secondary pieces.

Aspect 25 of this disclosure pertains to the multi-piece curved glass laminate article of any one of Aspects 14 to 24, wherein the primary piece comprises a primary outer surface and the secondary piece comprises a secondary outer surface; wherein, when the secondary piece is disposed in the aperture of the primary piece, the primary and secondary outer surfaces compose a composite outer surface comprising a continuous curvature across the primary and secondary pieces.

Aspect 26 of this disclosure pertains to the multi-piece curved glass laminate article of any one of Aspects 14 to 25, wherein the first glass ply and the second glass ply are co-sagged plies.

Aspect 27 of this disclosure pertains to an automotive glazing, comprising: a window having a first exterior surface and a first interior surface, the first exterior surface and the first interior surface defining a thickness of the window, wherein a hole is formed through the thickness of the window; an insert having a second exterior surface and a second interior surface, wherein the insert has a size and a shape configured to fit into the hole of the window; and a track system located on the first interior surface of the window and configured to allow the insert to move from a first position in which the insert obstructs a first area of the aperture to a second position in which the insert obstructs a second area of the aperture, the second area being smaller than the first area; wherein the window and the insert are laminated articles cut from the same two co-sagged glass plies.

Aspect 28 of this disclosure pertains to the automotive glazing of Aspect 27, wherein the window is at least one of a rear or side window of a vehicle or a sunroof.

Aspect 29 of this disclosure pertains to the automotive glazing of Aspect 27 or 28, wherein, in the first position, the second exterior surface of the insert is flush with the first exterior surface of the window.

Aspect 30 of this disclosure pertains to the automotive glazing of any one of Aspects 27 to 29, wherein the glass plies comprise a first glass ply and a second glass ply and wherein the first glass ply is an alkali aluminosilicate glass or an alkali aluminoborosilicate glass.

Aspect 31 of this disclosure pertains to the automotive glazing of Aspect 30, wherein the second glass ply is a soda lime glass.

Aspect 32 of this disclosure pertains to the automotive glazing of Aspects 30 or 31, wherein the first glass ply is chemically strengthened.

Aspect 33 of this disclosure pertains to the automotive glazing of any one of Aspects 30 to 32, wherein the second glass ply is chemically strengthened.

Aspect 34 of this disclosure pertains to the automotive glazing of any one of Aspects 30 to 33, wherein the first glass ply has an average thickness of from 0.3 mm to 1 mm.

Aspect 35 of this disclosure pertains to the automotive glazing of any one of Aspects 30 to 34, wherein the second glass ply has an average thickness of from 1.5 mm to 4 mm.

Aspect 36 of this disclosure pertains to the automotive glazing of any one of Aspects 27 to 35, wherein, when the insert is disposed in the hole of the window, the glazing comprises a continuous curvature across the first and second interior surfaces.

Aspect 37 of this disclosure pertains to the automotive glazing of any one of Aspects 27 to 36, wherein, when the insert is disposed in the aperture of the window, the glazing comprises a continuous curvature across the first and second exterior surfaces.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A method of preparing a multi-piece laminated article, comprising the steps of:
co-sagging a first glass ply and a second glass ply;
laser cutting the first glass ply to form a first primary piece and a first secondary piece and the second glass ply to form a second primary piece and a second secondary piece, the first primary piece and the second primary piece defining a hole into which the first secondary piece and the second secondary piece, respectively, fit; and
laminating the first primary piece to the second primary piece to form a first laminated piece and laminating the first secondary piece to the second secondary piece to form a second laminated piece.

2. The method of claim 1, further comprising chemically strengthening the first primary piece and the first secondary piece after the laser cutting.

3. (canceled)

4. The method of claim 1, wherein the first glass ply is an alkali aluminosilicate glass composition or an alkali aluminoborosilicate glass composition and the second glass ply is a soda lime glass composition.

5. (canceled)

6. The method of claim 1, wherein the first glass ply has an average thickness, T1, and the second glass ply has an average thickness, T2, wherein T1 is at least 2.5 times greater than T2 or T2 is at least 2.5 times greater than T1.

7. (canceled)

8. (canceled)

9. (canceled)

10. (canceled)

11. The method of claim 1, further comprising mounting the second laminated piece to the first laminated piece with a track system configured to allow the second laminated piece to move from a first position in which the second laminated piece obstructs a first area of the hole to a second position in which the second laminated piece obstructs a second area of the hole, the second area being smaller than the first area.

12. The method of claim 1, wherein the first laminated piece comprises an outer surface of the first primary piece facing an inner surface of the second primary piece, and the second laminated piece comprises an outer surface of the first secondary piece facing an inner surface of the second secondary piece.

13. The method of claim 12, wherein the outer surfaces of the first and second primary pieces are convex and the inner surfaces of the first and second secondary pieces are concave.

14. A multi-piece curved glass laminate article, comprising:
a primary piece having a hole formed therethrough, the primary piece comprising a first glass ply laminated to a second glass ply;
a secondary piece, wherein the secondary piece has a size and a shape configured to fit into the hole of the primary piece and wherein the secondary piece comprises a first glass ply laminated to a second glass ply;
wherein the first glass ply of the secondary piece is cut from the first glass ply of the primary piece; and
wherein the second glass ply of the secondary piece is cut from the second glass ply of the primary piece.

15. The multi-piece curved glass laminate article of claim 14, wherein the first glass plies are an alkali aluminosilicate glass or an alkali aluminoborosilicate glass and the second glass plies are a soda lime glass.

16. (canceled)

17. The multi-piece curved glass laminate article of claim 14, wherein the first glass plies have an average thickness, T1, and the second glass plies have an average thickness, T2, wherein T1 is at least 2.5 times greater than T2 or T2 is at least 2.5 times greater than T1.

18. (canceled)

19. (canceled)

20. The multi-piece curved glass laminate article of claim 14, further comprising a track system configured to allow the secondary piece to move from a first position in which the secondary piece obstructs a first area of the hole to a second position in which the secondary piece obstructs a second area of the hole, the second area being smaller than the first area.

21. The multi-piece curved glass laminate article of claim 20, wherein, in the first position, an outer surface of the first ply of the secondary piece is flush with an outer surface of the first ply of the primary piece.

22. (canceled)

23. The multi-piece curved glass laminate article of claim 14, wherein the first glass ply is curved, and the second glass ply is curved.

24. The multi-piece curved glass laminate article of claim 14, wherein the primary piece comprises a primary inner surface and the secondary piece comprises a secondary inner surface;
wherein, when the secondary piece is disposed in the hole of the primary piece, the primary and secondary inner surfaces form a composite inner surface comprising a continuous curvature across the primary and secondary pieces.

25. The multi-piece curved glass laminate article of claim 14, wherein the primary piece comprises a primary outer surface and the secondary piece comprises a secondary outer surface;
wherein, when the secondary piece is disposed in the hole of the primary piece, the primary and secondary outer surfaces form a composite outer surface comprising a continuous curvature across the primary and secondary pieces.

26. (canceled)

27. An automotive glazing, comprising:
a window having a first exterior surface and a first interior surface, the first exterior surface and the first interior surface defining a thickness of the window, the window defining a hole through the thickness thereof;
an insert having a second exterior surface, a second interior surface, and a size and a shape configured to fit into the hole of the window;
a track system located on the first interior surface of the window and configured to allow the insert to move from a first position in which the insert obstructs a first area of the hole to a second position in which the insert obstructs a second area of the hole, the second area being smaller than the first area; and
wherein the window and the insert are laminated articles cut from the same two co-sagged glass plies.

28. The automotive glazing of claim 27, wherein the window comprises at least one of a rear window, a side window, or a sunroof of a vehicle.

29. The automotive glazing of claim 27, wherein, in the first position, the second exterior surface of the insert is flush with the first exterior surface of the window.

30. The automotive glazing of claim 27, wherein the glass plies comprise a first glass ply and a second glass ply and wherein the first glass ply is an alkali aluminosilicate glass or an alkali aluminoborosilicate glass and the second glass ply is a soda lime glass.

31. (canceled)

32. (canceled)

33. (canceled)

34. (canceled)

35. (canceled)

36. The automotive glazing of claim 27, wherein, when the insert is disposed in the hole of the window, the window comprises a continuous curvature across the first and second interior surfaces.

37. (canceled)
